(19) United States
(12) Patent Application Publication
(10) Pub. No.: US 2013/0331056 A1
(43) Pub. Date: Dec. 12, 2013

(54) Automatic Speech Message Validation of an Emergency Teletype Text Message

(71) Applicant: Guardity Technologies, Inc., Plano, TX (US)

(72) Inventors: Russell Carl McKown, Richardson, TX (US); Joseph Thomas Mader, Plano, TX (US)

(21) Appl. No.: 13/907,889

(22) Filed: Jun. 1, 2013

Related U.S. Application Data
(60) Provisional application No. 61/658,575, filed on Jun. 12, 2012.

(51) Int. Cl. H04W 4/22

(52) U.S. Cl. CPC H04W 4/22
USPC 455/404.1

(57) ABSTRACT

The present application provides a system, method and non-transitory computer readable medium of using automatically generated speech messages to audibly validate text messages that are sent using TTY communications. A short length text message can be delivered using TTY communications which is then immediately followed by short-duration speech read-text message designed to either validate the received TTY text message or identify character errors in the same. The use of the VCO-TTY communications mode allows the called party to request resends of the automatically generated TTY text and the corresponding speech read-text messages.

### CROSS-REFERENCE TO RELATED APPLICATIONS

This application claim priority to U.S. provisional application No. 61/658,575, entitled “Automatic Speech Message Validation of an Emergency Teletype Text Message”, dated Jun. 12, 2012. This application is related to application Ser. No. 13/276,991, entitled “Detecting a Transport Emergency Event and Directly Enabling Emergency Services”, filed on Oct. 19, 2011, and Docket No. Guardity012012A entitled “Qualifying Automatic Vehicle Crash Emergency Calls to Public Safety Answering Points”, filed on even date herewith, and Docket No. Guardity012012B entitled “Qualifying Automatic Vehicle Crash Emergency Calls to Public Safety Answering Points”, filed on even date herewith, and Docket No. Guardity022012 entitled “Horn Input to In-Vehicle Devices and Systems”, filed on even date herewith, and Docket No. Guardity032012 entitled “Mounting Angle Calibration for an In-Vehicle Accelerometer Drive”, filed on even date herewith. The contents of which are hereby incorporated by reference in their entireties.

### FIELD OF THE APPLICATION

The present application relates to mobile communication devices, teletype (TTY) form of text telephone communications, emergency event detection, and more particularly, the automatic direct transfer and validation of event data to emergency service dispatch personnel when a transport emergency event is detected.

### BACKGROUND OF THE APPLICATION

Automated Emergency Event Notification (AEEN) telematics devices and systems can effectively and expeditiously directly notify 911 operators at the local Public Safety Answering Point (PSAP) of a transport emergency event. The 911 PSAP operators may then dispatch emergency personnel, such as an Emergency Medical Service (EMS) team, to the site of the transport emergency event. Emergency events may include vehicle or other transport crashes, fires, medical emergencies, or other threats to safety. The types of emergency events detected include those involving a crash of the vehicle or other transport and any other emergency that warrants calling 911 by activating a HELP/PANIC/MAYDAY/SOS/911 function. These transports include cars, trucks, buses, trains, motorcycles, boats, aircraft, etc. For convenience and readability, all transport entities will be referred to as “vehicles” herein.

Some of the existing vehicle emergency notification systems, e.g., the OnStar® system from General Motors, Inc., use automatic crash notification (ACN) capabilities to detect a crash and notify an associated telematics service provider (TSP) call center. For example, the oldest ACN systems may only detect crashes based on air-bag deployment and may just report their vehicle's GPS determined location whereas the newer, so-called advanced ACN (AACN) systems also incorporate accelerometer data for crash detection and analysis and report significantly more crash related data, such as vehicle speed, crash impact magnitude, angle of impact, rollover, multiple impacts and a computed injury severity prediction. These ACN and AACN telematics devices also support the general emergency HELP/MAYDAY function and, in the event of either type of emergency, establish voice and data communication with the TSP call center. The communication typically uses an in-vehicle cellphone that has a subscription with a wireless service provider (WSP) that includes both voice and data. The TSP operator then uses the vehicle location data to contact the 911 PSAP nearest to the accident location to request help. These systems also enable three-way voice communications between the vehicle occupants, the service center operator, and the 911 PSAP. Even if the occupants are unable to communicate, the location information is used to dispatch the closest emergency response services to the vehicle.

These ‘traditional’ AACN/TSP/PSAP emergency notification systems, which have been used by OnStar®, ATX, and Hughes TSP's, any time you use it have several recognized problems. A primary problem is that the TSP-to-PSAP calls do not take advantage of the priority 911 network infrastructure but instead, these calls are received by the PSAP on non-priority administrative phone lines. These non-priority lines may be in use for routine administrative purposes. Also, since this type of TSP-to-PSAP call is not in the priority 911 queue it may simply not be answered for a long time during times of high 911 call activity. Other problems arise from the methods used by the operator at the remote TSP call center to determine the appropriate local PSAP to call based on the client vehicle's GPS location. The TSP call center's location-indexed PSAP administrative phone number directory is quite possibly out-of-date. As a result, the wrong PSAP may be called. Finally, once the appropriate TSP-to-PSAP call is achieved, the PSAP operator is required to obtain the crash/emergency location from a verbal transmission; perhaps a street address but possibly the multi-digit GPS coordinate data. This round-about and error prone AACN-to-TSP-to-PSAP call procedure is in sharp contrast to a real 911 call to the PSAP wherein the caller's call-back number and location automatically and immediately appear on the 911 operator's display at the PSAP that is nearest to the 911 caller. After all, the U.S. enhanced 911 (e911) system is designed to provide the PSAP operator with the caller's call-back number, i.e., the automatic number information (ANI) and the caller's location, i.e., the automatic location information (ALI)—without error and within seconds.

In summary, the traditional AACN/TSP/PSAP emergency notification systems have problems regarding the timely delivery of critical data to the PSAP operator. This critical data is known to include not only the victim's call-back number and the vehicle crash location, but also vehicle crash analysis data.

The importance of providing the PSAP operator with this complete data set is known. From a medical viewpoint, Ellen J. MacKenzie, et al., published A National Evaluation of the Effect of Trauma-Center Care on Mortality in The New England Journal of Medicine, vol. 354 (2006) that indicates the risk of death is reduced by 25% for severely injured patients if they can be treated at a hospital with a level I trauma center compared to treatment at a hospital without a trauma center. Also in 2006, the Center for Disease Control (CDC) sponsored the National Expert Panel on Field Triage which updates the Revised Trauma Triage Guidelines. In the 2006 and subsequent updates of these formal guidelines, “vehicle telemetry data consistent with high risk of injury” are recognized as criteria for the decision to take an injured victim to a trauma center (see Guidelines in Resources for the optimal care of the injured patient: 2006. Chicago, Ill.: American College of Surgeons; 2006).

The CDC then established another expert panel that met in 2007 and 2008 to provide recommendations for enhancing the AACN/TSP/PSAP crash notification system. These recommendations are documented in Advanced Automatic Collision Notification and Triage of the Injured Patient, U.S. Dept. Health and Human Services, CDC (2008). This expert panel identified crash data important for an injury severity prediction (ISP) analysis and recommended a protocol for notifying the PSAP of these crash data and the ISP analysis.

Several approaches have been proposed for improving the delivery of vehicle call-back number, location and crash analysis data to the PSAP. Included in these approaches are:
the European Union's “eCall” initiative which enables a direct emergency, voice and high performance data call from the in-vehicle telematics control unit (TCU) to the PSAP—without any TSP;
a TSP initiated, “remote conference calling” method that places a direct 911 voice call from the in-vehicle TCU to the PSAP;
a TSP initiated, 911 call from telecommunication network elements to the PSAP and an indirect TSP-to-PSAP delivery of an ALI that contains crash data;
a direct 911 voice and/or TTY data call from the in-vehicle TCU to the PSAP with a concurrent data connection from the TCU to an Internet server—without any TSP; and
a direct 911 voice and TTY data call from the in-vehicle TCU to the PSAP—without any TSP.

The above approaches 2, 3 and 5 are described in Sections 3.2, 3.1/3.4 and 3.3, respectively, of Automatic Collision Notification and Vehicle Telematics Technical Information Document (TID), by David Irwin, NENA 07-504 (2007) which is incorporated in its entirety by reference herein. Each of the above listed approaches is considered below.

The “eCall” initiative of the European Union (EU) is developing a system that allows a direct in-vehicle TCU-to-PSAP 3-digit emergency voice call that includes the capability of transferring data using a high performance in-band modem. There are many documents describing eCall, for example, Harmonized eCall European Pilot, D2.1 Functional and Operational Requirements Report, ERTICO—ITS Europe, Ver. 1.0 (2011). The eCall plan has a legislative mandate to require that all new vehicles sold in Europe, say as soon as 2015, have eCall-standards-compliant telematics. These eCall compliant telematics systems contain a high performance in-band modem and can directly place an “e112” voice and data emergency call to a local PSAP in the event of a vehicle crash or HELP/MAYDAY emergency.

The EU eCall initiative requires the EU Member States to make sure their mobile operators (WSPs) and PSAP centers are eCall-compliant. The EU mobile operators are required to implement an eCall flag in their networks that identify “112” calls as “e112” calls when they originate from an eCall in-vehicle TCU. The EU PSAP centers are required to upgrade their telecommunication equipment to include the special eCall in-band modems. With these eCall modems, the e112 call can systematically switch between voice and fast and reliable data transmissions. Given continued European Union support, a mandated eCall system deployment can be expected to significantly improve the EMS response to vehicle crashes so that lives are saved and permanent injuries are lessened—in Europe.

The remaining approaches 2 to 5 listed above—and the present application—are concerned with improving the transfer of vehicle call-back number, location and crash analysis data to the 911 PSAP centers as they presently operate in the U.S. The Next Generation 9-1-1 (NG9-1-1) initiative intends to augment the current 911 voice call PSAP system with an Internet Protocol based emergency network (see for example, NG9-1-1 System Initiative—System Description and Requirements Document, ITS, U.S. Dept. of Transportation, Ver. 2.0, 2007). In so doing, the NG9-1-1 initiative will eventually solve the general problem of delivering data to the PSAP, including the immediate problems of interest. However, given their potential to save lives and lessen severe injuries, solutions to these problems with the current U.S. 911 PSAP system are desired.

Consider the second listed approach: a TSP initiated, “remote conference calling” method that places a direct 911 voice call from the in-vehicle TCU to the PSAP. This approach allows the TSP operator to initiate a 911 call from the vehicle TCU to the PSAP. The initial call in this approach is the traditional voice and data call from the AACN device to the TSP based on an emergency event trigger. The AACN TCU is here designed to listen for a specified command from the equipment of the TSP operator and upon receipt of the command initiates a 3-way 911 voice call to ‘conference in’ the appropriate PSAP operator that is local to the vehicle. This method is attractive in that it provides the PSAP with a standard 911 call that includes the e911 network provided call-back phone number to the occupants of the vehicle and location. However, the method does not provide an improved means of reliably transmitting the additional crash analysis data to the PSAP. This data must still be transferred using voice communication between the TSP and PSAP operators.

Consider the third above listed approach: a TSP initiated, 911 call from telecommunication network elements to the PSAP and an indirect TSP-to-PSAP delivery of an ALI that contains crash data. As discussed in Characterization of Pathways for Delivery of Crash Telemetry Data to Montana, (2011), Intrado Inc. currently offers PSAP centers a ‘Priority Access’ mechanism that is based on this approach and is available with the OnStar, ATX, and Hughes Telematics TSPs. According to one example, from the viewpoint of the PSAP operator, his or her equipment receives a 911 call which: 1) is identified as coming from a TSP and 2) contains an ALI record that has been generated by the TSP. These fields can, for example, contain location data (e.g., latitude/longitude), a TSP 24×7 call-back number and the crash data analysis data. This ‘Priority Access’ approach solves many of the problems associated with the traditional AACN/TSP/PSAP system in which the TSP operator contacts the PSAP by calling an administrative phone line. However, the only access to the person in the vehicle is still through the TSP. There is no provision for a direct 911 call from the in-vehicle TCU to the PSAP—which would provide the PSAP operator the desired vehicle call-back number and location.

Consider the fourth listed approach: a direct 911 voice and/or TTY data call from the in-vehicle TCU to the PSAP with a concurrent data connection from the TCU to an Internet server—without any TSP. In this method the in-vehicle/mobile TCU maintains two wireless links: a 911 call to the PSAP and a data connection link to an Internet server. It requires the Internet address of the Internet server to be sent with other data to the PSAP operator over the standard 911 voice/TTY connection. Assuming some provision for Internet web access, the PSAP operator and designated first responders can logon to the Internet server to access the crash related data of interest. However, the transfer of the Internet address is critical here and requires a reliable data transmission to the PSAP over the 911 voice/TTY call. This problem is the focus of the present application.

Consider the fifth listed approach: a direct 911 voice and TTY data call from the in-vehicle TCU to the PSAP - without any TSP. This approach is the same as the fourth approach but without the concurrent data connection. The data transfer explicitly relies on TTY communication between the in-vehicle TCU and the PSAP during the 911 call. In support of the 1990 Americans with Disabilities Act (ADA), PSAP call centers maintain TTY equipment and train their operators to use the equipment for 911 calls from people who have impaired hearing and/or speech. In principle, it is feasible for an in-vehicle TCU to initiate a direct 911 call to a PSAP and use TTY communications to transfer the crash related data of interest. The problem with this approach is again the difficulty of reliably transmitting data to the PSAP over a 911 voice/TTY call.

The Baudot standard form of TTY communications in the U.S. is slow and susceptible to error. The TTY bit rate is only 45.45 bits per second for transferring around 8 characters per second. TTY has no native error correction capability and wireless TTY may have character error rates of 1% or higher. As originally designed and deployed, the 2G wireless digital networks, i.e., CDMA, TDMA and GSM, used voice codecs that severely degrade TTY communications. This problem and the 1990 ADA mandate resulted in a 1997 FCC ruling, “Revision of the Commission's Rules to Ensure Compatibility with Enhanced 911 Emergency Calling Systems”, CC Docket No. 97-402, which required the cellular telecommunications industry to develop solutions so that wireless TTY has the same functionality as wireline TTY. The wireless industry's subsequent TTY Forum defined an acceptable wireless TTY character error rate of not more than 1%. This goal was achieved with different solutions for GSM networks versus CDMA and TDMA networks as discussed, for example, by Matthias Dorbecker, Karl Hellwig, Fredrik Jansson, and Tomas Frankkila in “The cellular text telephone modem—the solution for supporting text telephone functionality in GSM networks”, ICASSP '01 Proceedings of the Acoustics, Speech, and Signal Processing, Vol. 03, IEEE (2001). Dorbecker et al., report that prior to these 2G wireless TTY solutions, a character error rate of 5% was considered to be unacceptable for TTY. Compared to error rates of modern digital communication systems, wherein the error rates are typically less than 0.001%, an error rate of either 1% or 5% is very high. Furthermore, the ‘acceptable’ character error rate of 1% that was specified by the cellular industry's Wireless TTY Forum is within only a factor of 5 of the ‘unacceptable’ character error rate of 5%.

Whether an error rate is acceptable or not depends on the communications' context. For TTY communication of the typed ‘instant message’ form of conversation between two people, a 1% character error rate is acceptable—it has been part of such conversations for decades using wireline TTY. For TTY communications of critical conversations between a 911 caller and a PSAP operator, a 1% character error rate is still somewhat acceptable for the same reason, the humans in the conversation can ask for clarification/resend of important or garbled information. However, for TTY communications involving automatically generated crash related data from an in-vehicle TCU to a 911 operator; the 1% character error rate may be problematic. For example, an immediate EMS response is typically not required for a vehicle crash with an impact delta velocity (delta-V) of 10 miles per hour (mph) but is required for a vehicle crash with delta-V of 50 mph. A PSAP operator may error in the EMS dispatch decision based on a TTY character error that causes a transmitted “5” to be received as “1”.

To validate emergency event data sent to an operator using wireless TTY communications from an in-vehicle/mobile TCU to a 911 PSAP would be optimal if incorporated into the vehicle safety. In practice, the wireless TTY character error rate cannot be assumed to be 1% or less. The modifications to the digital cellular networks to better support TTY communications work only if the network equipment has been updated and the end user equipment (at both ends) has the ability and is properly configured to support these changes. The probability of network/equipment problems is seen as significant given that the wireless networks maintain lists of TTY-compatible wireless devices and wireless-compatible TTY devices and each has their own instructions to properly configure them for wireless TTY. When present, these end-to-end equipment incompatibility problems result in an increased character error rate for wireless TTY communications. Indeed, the FCC Consumer & Governmental Affairs Office maintains an Emergency Communications Guide which in 2012 warns, “In certain locations, however, TTY users may not be able to complete 911 calls using these newly available digital wireless services.” In summary, a method to validate emergency event data that is sent using TTY on a 911 call from an in-vehicle TCU to a PSAP would be optimal.

### SUMMARY OF APPLICATION

In general, the present application provides a system and method for using automatically generated speech messages to audibly validate text messages that are sent using TTY communications. A short length text message can be delivered using TTY communications and immediately followed by an automatically generated, short-duration speech message that is designed to either validate or identify character errors in the received text.

In some embodiments, following the time period that includes the sending of both the TTY Text Message and the subsequent Speech Read-text Message, there is an immediate activation of 2-way voice communication between the caller and called parties. In other embodiments, this time period is followed by an opportunity to request a resending of the TTY Text and Speech Read-text Messages before activation of 2-way voice communications. The latter embodiment allows for additional attempts to successfully transfer the TTY Text Message when the TTY character error rate is high. Character error detection is based on observing that the received TTY Text Message does not agree with the Speech Read-text Message. A known benefit of receiving an error free TTY Text Message is that if the receiving TTY terminal is a computer software application, then the received text can be easily logged or transferred into other applications, for example, using familiar ‘cut and paste’ techniques. Such a transfer of a text message is not desirable if the received text contains character errors.

Some embodiments of the application will be described herein as solutions of the problem of getting crash related data directly from the TCU of an in-vehicle ACN/AACN/AEEN device or system to a U.S. based 911 PSAP operator—without the involvement of a TSP. For example, FIG. 1 shows a diagram of a vehicle 110 that contains an in-vehicle AEEN device 120 capable of determining if an emergency event has occurred (i.e., airbag deployment 130). If so, the TCU of the AEEN device is capable of utilizing an integrated, possibly non-activated, cellphone to place a direct call to a 911 operator at a PSAP dispatch center 160 using the access point 140 of the most readily available wireless network 150 and deploy EMS 170. As depicted in FIG. 1, an emergency event can be a crash of the vehicle into a tree.

By directly calling 911, the in-vehicle TCU takes advantage of the e911 system that delivers the victim's call-back number and location to the appropriate nearby PSAP operator. In the application, upon establishing the 911 call connection, the TCU immediately initiates the TTY communications mode and transfers to the PSAP operator a short TTY Text Message that contains the crash related data of interest. The TCU then immediately, i.e., in real-time or near real-time, terminates the TTY mode and delivers an automatically generated Speech Read-text Message, of the same form and content as the TTY Text Message. In this manner, it is natural for the PSAP operator to inspect the typed TTY Text Message while listening to the Speech Read-text Message and in so doing, either validate the typed message or identify character errors in same.

In some embodiments, the application takes advantage of the known small number of data parameters to be transferred and the limited number of required values of each parameter. In such embodiments, the Speech Read-text Message may be compiled from the TTY Text Message using a prerecorded audio library of spoken words and numbers using techniques that are known as ‘voice response’ processing. In other embodiments, known ‘text-to-speech’ processing technologies can be used to generate the Speech Read-text Message from text input allowing the validation of a TTY Text Message with arbitrary content. An advantage of these text-to-speech embodiments is that they can also support validation of TTY text communications of longer duration, provided the communications is segmented into relatively short messages for sequential paired transmission of TTY Text and Speech Read-text Messages. A desirable short message length for all of the embodiments is one in which the TTY text message fills but does not overflow one-line of text as displayed on the receiving TTY equipment. This allows the receiving operator to easily view the TTY Text Message while listening to the Speech Read-text Message.

One example embodiment may include a method that includes receiving motor vehicle emergency sensor data, identifying an emergency event has occurred in a motor vehicle based on the emergency sensor data, generating an emergency text message via a mobile communication device associated with the vehicle comprising a summary of at least one of a vehicle emergency event and the associated emergency sensor data, transmitting the emergency text message to emergency services, generating an automated voice speech message that audibly reads the emergency text message data to an emergency services recipient, and transmitting the voice speech message to the emergency services recipient.

Another example embodiment may include an apparatus that includes a receiver configured to receive motor vehicle emergency sensor data, a processor configured to identify an emergency event has occurred in a motor vehicle based on the emergency sensor data, generate an emergency text message comprising a summary of at least one of a vehicle emergency event and the associated emergency sensor data, and a transmitter configured to transmit the emergency text message to emergency services. The processor is also configured to generate an automated voice speech message that audibly reads the emergency text message data to an emergency services recipient, and wherein the transmitter is further configured to transmit the voice speech message to the emergency services recipient.

Yet another example embodiment may include a non-transitory computer readable storage medium configured to store instructions that when executed cause a processor to perform receiving motor vehicle emergency sensor data, identifying an emergency event has occurred in a motor vehicle based on the emergency sensor data, generating an emergency text message via a mobile communication device associated with the vehicle comprising a summary of at least one of a vehicle emergency event and the associated emergency sensor data and transmitting the emergency text message to emergency services, generating an automated voice speech message that audibly reads the emergency text message data to an emergency services recipient, and transmitting the voice speech message to the emergency services recipient.

### BRIEF DESCRIPTION OF THE DRAWINGS

FIG. 1 depicts a diagram of an AEEN system to directly notify 911 services of a detected emergency event in one embodiment.

FIG. 2A depicts a diagram of an embodiment in which an AEEN device or system places a direct 911 call in response to either a HELP/MAYDAY request.

FIG. 2B depicts a diagram of an embodiment in which an automatic detection of a vehicle crash is performed.

FIG. 3A depicts a diagram of a system that generates TTY Text and Speech Read-text Messages in one embodiment.

FIG. 3B depicts a diagram of a system that generates a TTY Text Message and generates the corresponding Speech Read-text Message using a text- to-speech technology in one embodiment.

FIG. 3C depicts a diagram of a system that generates TTY Text Message and generates the corresponding Speech Read-text Message using a voice response synthesis technology in one embodiment.

FIG. 4 depicts a top-level sequence diagram of a system to place a 911 call, and send the TTY Text and Speech Read-text Messages to the 911 PSAP in one embodiment.

FIG. 5 depicts a more detailed diagram of a system to place a 911 call, and send the TTY Text and Speech Read-text Messages to the 911 PSAP in one embodiment.

FIG. 6 depicts a top-level sequence diagram of a system to place a 911 call, send the TTY Text and Speech Read-text Messages, and ask if a resend is required in one embodiment.

FIG. 7 depicts a more detailed diagram of a system to place a 911 call, send the TTY Text and Speech Read-text Messages, and ask if a resend is required in one embodiment.

FIG. 8 depicts a diagram of a processor and a connected memory that can be resident on one or more of the devices or operations according to an embodiment of the application.

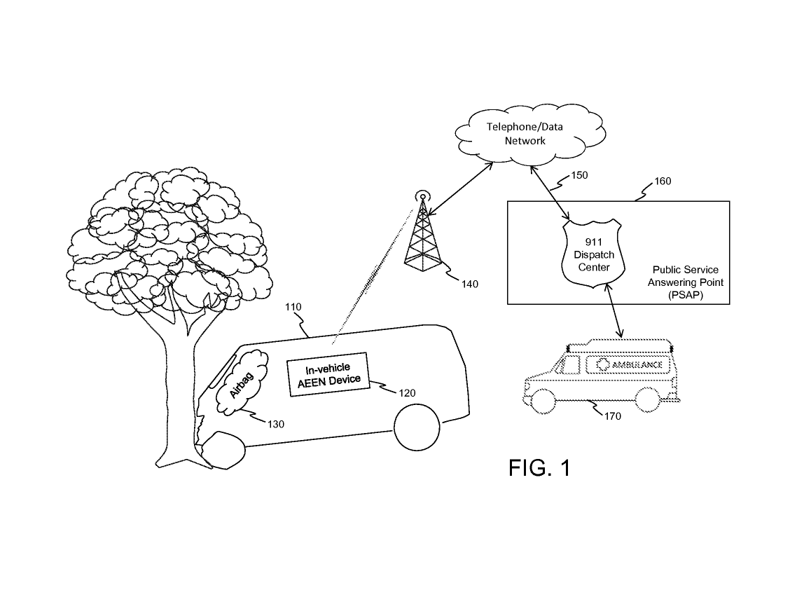

### DETAILED DESCRIPTION OF THE APPLICATION

The present application provides a system, method and non-transitory computer readable medium that provides a means of using automatically generated speech messages to audibly validate text messages that are sent using TTY communications. A short length text message can be delivered using TTY communications and immediately followed by an automatically generated, short-duration speech message that is designed to either validate or indicate an error in the TTY text message. Like identifiers and reference numerals in the various drawings represent like elements and operations.

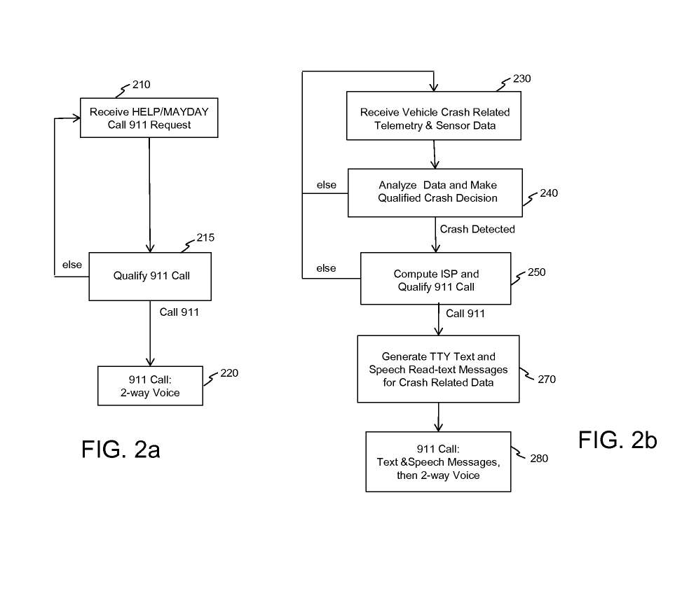

FIG. 2A shows a block diagram of an example embodiment of the present application in which an AEEN device or system places a direct 911 call in response to either a HELP/MAYDAY request or an automatic detection of a vehicle crash. In this particular example, in FIG. 2A, if a HELP/MAYDAY request is received 210 the in-vehicle TCU simply directly calls 911 220 and initiates a 2-way voice call between the occupants of the vehicle and the 911 operator at a PSAP dispatch center if the 911 call is qualified 215.

The processing for the automatic detection of a vehicle crash in FIG. 2B contains the processing operations 270 and 280 of the present application that are responsible for sending crash related data to the PSAP center. In other embodiments, the HELP/MAYDAY request may also send emergency event data to the PSAP center. In that case a corresponding figure would include operations similar to 270 and 280 under the HELP/MAYDAY request 210.

Regarding the ACN associated operations 230 to 280 in FIG. 2B, operation 230 receives the vehicle's emergency sensor data which includes, for example, crash related telemetry, e.g., airbag deployment or fuel cutoff indicators and crash sensors, e.g., 2-axis or 3-axis accelerometers to detect the impact and possibly crash sound or crush zone sensors. This data is input to operation 240 which analyzes and qualifies the data for the purposes of making a crash decision. If a crash is detected, operation 240 also computes the ISP (injury severity prediction) which is a probability of serious injury in units of percent (%). If there is no crash detected, control operation 250 returns control to the receive data operation 230, but if a crash is detected the next processing depends on the computed value of ISP. A low ISP value, say 1%, indicates a low probability of serious injury, in which case operation 260 asks the vehicle operator if he or she wants to call 911. If the answer is ‘yes’ operations 270 and 280 of the present application are activated and a direct 911 call is initiated. If the answer is “no” control returns to receive data 230. Various user-to-device interface technologies may be used to communicate the ‘yes’ or ‘no’ information from the vehicle operator. A higher ISP value, say 15%, indicates a higher probability of serious injury and warrants an AEEN-to-PSAP 911 emergency call without the need to consult the vehicle operator. In this case control operation 250 directly activates operations 270 and 280. The ISP threshold for making this decision to call 911 without consulting the vehicle operator may, for example, be in the range of 10%.

Continuing to refer to the diagram in FIG. 2B of an example embodiment of the present application; when the ACN logic decides to call 911, operation 270 is activated to generate a TTY Text Message and a corresponding Speech Read-text Message. These messages contain crash related data that are of interest to the 911 PSAP operator. This crash related data may include, for example, the Delta-V, impact angle, seatbelt usage, multiple impacts and vehicle type and, in addition, an ISP that is based on these data. The TTY Text Message and corresponding Speech Read-text Message generated by operation 270 are then input to operation 280 which: 1) initiates the 911 call, 2) sends the text and speech messages to the 911 operator at the PSAP and 3) establishes a 2-way voice call between the 911 operator and the vehicle occupants. Details relating to these steps will be described in more detail below.

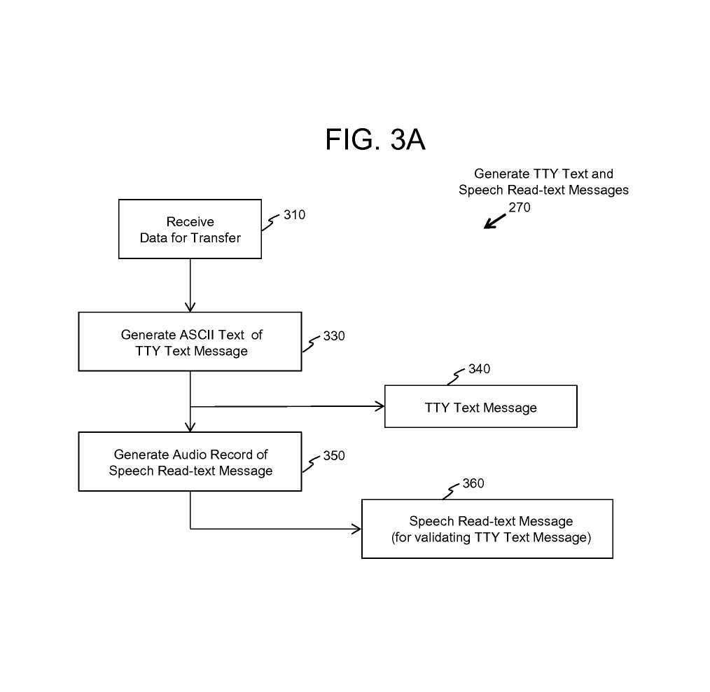

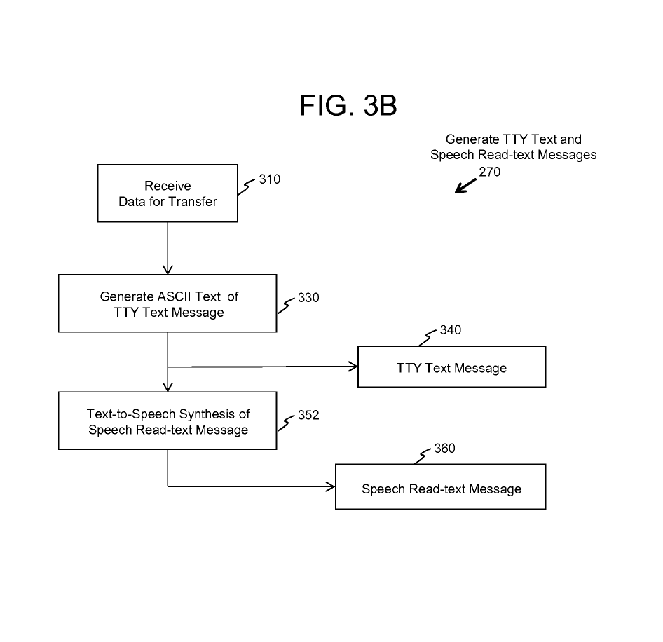

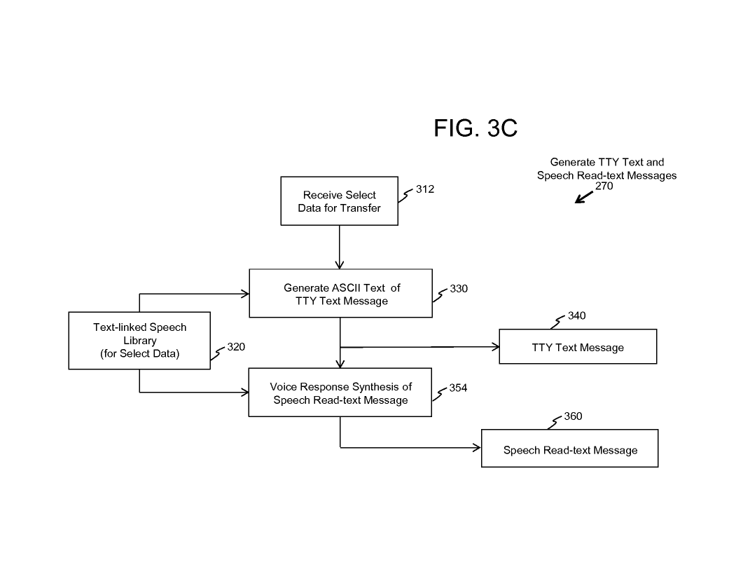

FIGS. 3A, 3B, and 3C illustrate block diagrams of example embodiments based on operation 270 of FIG. 2B of the present application in which the data for transfer is used to generate the text and speech messages. Referring to FIG. 3A, operation 310 receives the data for transfer which is then input to operation 330 which generates the ASCII text of the TTY Text Message 340. The voice response synthesis of a speech read-text message 354 may be identified based on the ASCII text. This TTY Text Message is input to operation 350 which generates an audio record that is the Speech Read-Text Message 360. By design, if the 911 operator looks at a received TTY Text Message displayed on the PSAP TTY equipment while simultaneously listening to the audio of the Speech Read-Text Message, then the operator should be able to readily identify TTY character errors—if they exist. Note that this operator based error identification processing may instead be replaced by an automatic machine/computer based error identification processing. For example, optical character ‘reading’ technologies and speech recognition technologies may be used to automatically perform this TTY character error identification. The Speech Read-Text Message is a ‘reading’ of the TTY Text Message for the purpose of communicating the data for transfer. For example, in some embodiments the generated Speech Read-Text Message may make use of the NATO Phonetic Alphabet, e.g., ‘alpha’, ‘bravo’, ‘Charlie’, etc.; in other embodiments it may just read aloud the text of the TTY Text Message. Both the TTY Text Message and the Speech Read-Text Message are expected to be in English for the U.S. but may be in other languages for countries with similar PSAP systems but different languages.

Referring to FIG. 3B, the function-specified operation 350 of FIG. 3A has been replaced by an implementation-specified operation 352. In this embodiment a text-to-speech synthesis technology is used to create the Speech Read-Text Message audio from the text in the TTY Text Message. All other same-labeled operations may be deemed the same as in FIG. 3A.

Referring to FIG. 3C, the function-specified operation 350 of FIG. 3A has been replaced by an implementation-specified operation 354. In this embodiment a voice response synthesis technology is used to create the Speech Read-Text Message audio from the text in the TTY Text Message. As is well known, voice response speech synthesis forms sentences by concatenating pre-recorded words from a database. This technology is appropriate when the messaging requirements use a limited vocabulary and the sentences and/or phrases follow predetermined patterns, for example as in airline gate information messages. The select data for transfer 312 and a simple formatting of the TTY Text Message satisfy these requirements. This allows the creation of a pre-recorded Select Data/Text-linked Speech Library (database) 320 that can be used for the Voice Response Synthesis in operation 354 to build the Speech Read-Text Message 360.

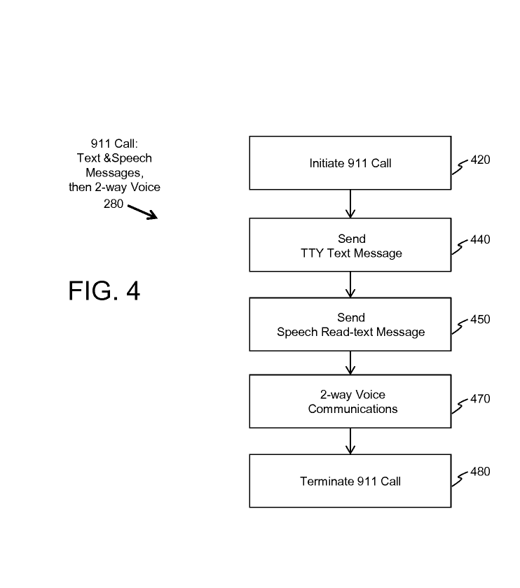

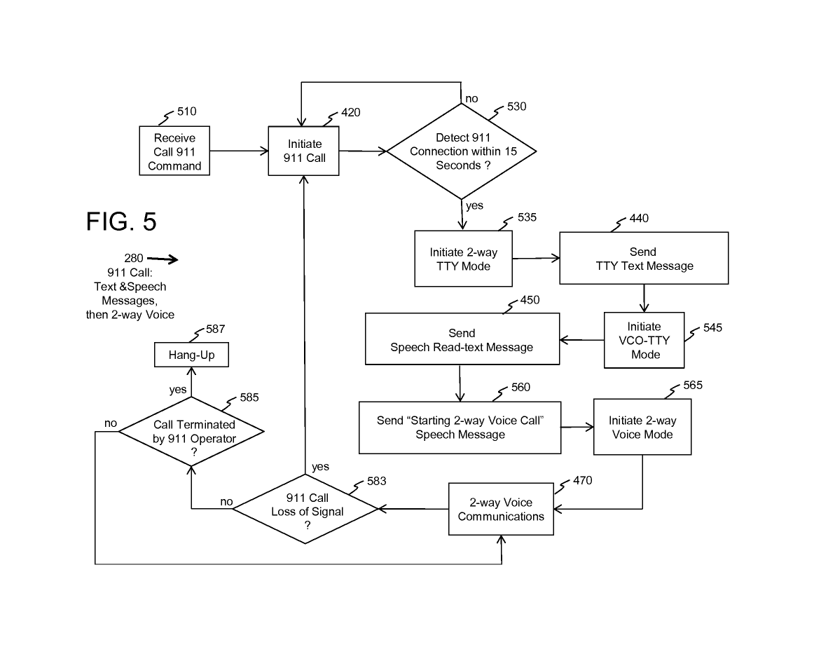

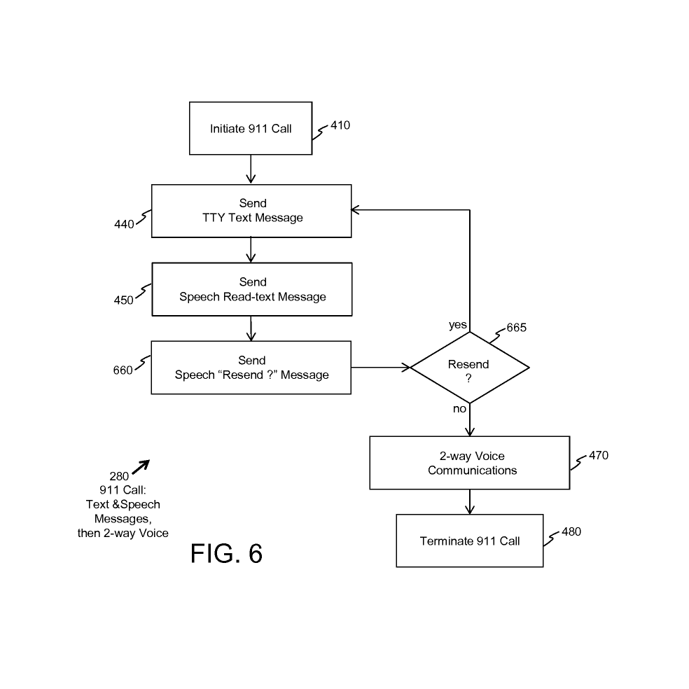

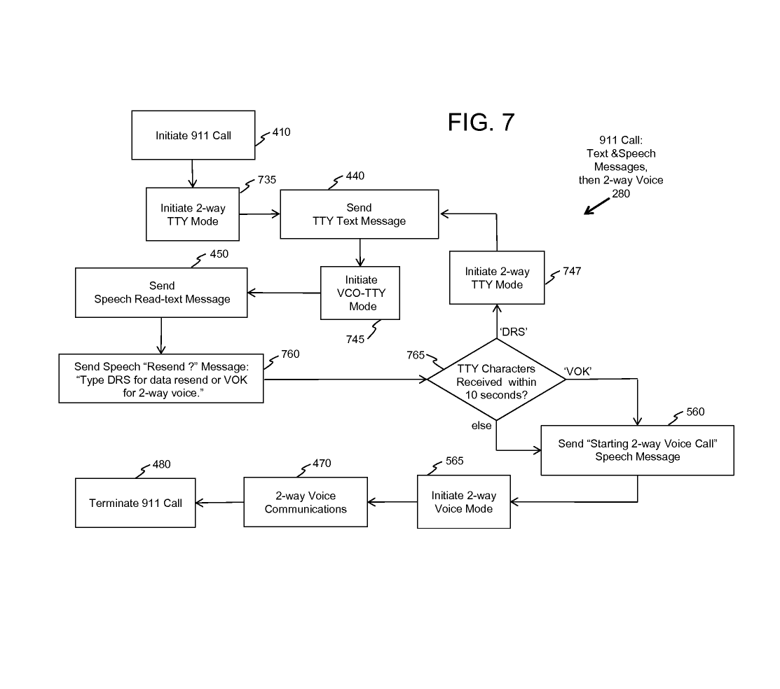

FIGS. 4, 5, 6, and 7 illustrate block diagrams of example embodiments based on operation 280 of the present application which makes a 911 call, transfers the select data of interest using the TTY Text and Speech Read-text Messages, and then provides a 2-way voice call between the vehicle occupants and the 911 operator. FIGS. 4 and 5 illustrate embodiments that do not include a resend data request, whereas FIGS. 6 and 7 illustrate embodiments that do.

Referring to a top-level sequence diagram for operation 280 in FIG. 4, the 911 call is initiated 420, the TTY Text Message is sent 440, the corresponding Speech Read-Text Message is sent 450, 2-way voice communications are established 470, and finally, the 911 call is terminated 480.

Referring to a more detailed diagram in FIG. 5, the command is received to initiate a 911 call 510, the call is initiated 420 and the time to connect is monitored 530 so that if a connection is not established within, say, 15 seconds then the call is reinitiated 420. Once the 911 call is established, the in-vehicle TCU immediately initiates the 2-way TTY communications mode 535 and sends the TTY Text Message to the PSAP TTY equipment 440. Immediately after sending the TTY Text Message, the in-vehicle TCU initiates/requests the Voice Carry Over TTY (VCO-TTY) communications mode 545 in which the 911 operator listens for speech from the calling party (but retains the ability to transmit TTY to the calling party). The in-vehicle TCU then sends the Speech Read-text Message 445 to the PSAP followed by a pre-recorded “Starting 2-way Voice Call” Speech Message 560 and initiates/requests the 2-way voice communications mode 565 between the occupants of the vehicle and the 911 operator. This 2-way voice call 470 continues until either: 1) a loss of signal occurs 583 wherein the TCU reinitiates the 911 call 420 or 2) the call is terminated by the 911 operator 585 at which time the TCU does likewise 587.

Note that at operation 545 in FIG. 5, the in-vehicle TCU initiates/requests the VCO-TTY communications mode. In other embodiments the TCU may directly initiate/request the 2-way voice communications mode. However, the VCO-TTY communications mode is preferred because: 1) it is consistent with the procedures required in the ‘resend data request’ embodiments, discussed below, and 2) it indicates to the 911 operator that the machine generated speech that immediately follows does not require his or her spoken response.

FIG. 6 is a top-level sequence diagram of another embodiment of operation 280. In this embodiment, the 911 call is initiated 420, the TTY Text Message is sent 440, the corresponding Speech Read-Text Message is sent 450, and then a pre-recorded Speech ‘Resend?’ Message is sent 660 to the 911 operator. If the 911 operator responds ‘yes’ 665, then operations 440, 450 and 660 are repeated in an effort to transfer the data contained in the TTY Text Message without character error. If the 911 operator responds ‘no’ 665, the 2-way voice communications 470 is established until it is terminated by the 911 operator 480.

Referring to a more detailed diagram of this embodiment in FIG. 7, once the 911 call is initiated/established 410, the in-vehicle TCU again immediately initiates/requests the 2-way TTY communications mode 735 and sends the TTY Text Message to the PSAP TTY equipment 440. The in-vehicle TCU then initiates the Voice Carry Over TTY (VCO-TTY) communications mode 745 in which the 911 operator listens for speech from the calling party and retains the ability to transmit TTY to the calling party. The in-vehicle TCU then sends the Speech Read-text Message 445 to the PSAP followed by a pre-recorded “Type D-R-S for data resend or V-O-K for 2-way voice.” Speech Message 760. At this point, 765, the in-vehicle TCU processes the incoming TTY characters from the PSAP and decides if in the next, say, 10 seconds, that the PSAP has sent the characters ‘DRS’ or not. If it is decided at 765 that the ‘DRS’ characters were sent, then the in-vehicle TCU again initiates the 2-way TTY communications mode 747 and the re-executes operations 440, 445, 450, and 765. If it is decided at 765 that the ‘DRS’ characters were not sent from the PSAP, the in-vehicle TCU sends the pre-recorded “Starting 2-way Voice Call” Speech Message 560 and initiates 2-way voice communications mode 565 between the occupants of the vehicle and the 911 operator. This 2-way voice call 470 continues until it is terminated by the 911 operator 480 per standard PSAP protocol.

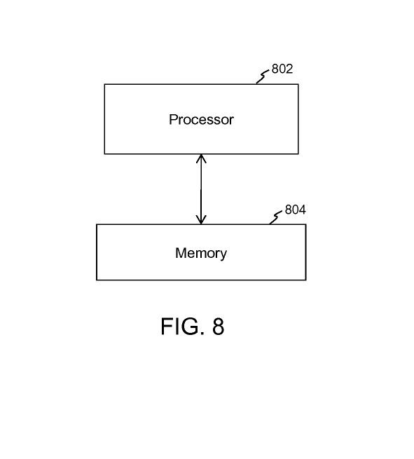

Note that any reference to an algorithm described or depicted herein is software or a computer program that is run by a processor resident on one or more devices or operations described or depicted herein. FIG. 8 depicts a processor 802 and a connected memory 804 that can be resident on any of the devices described or depicted herein, for example an AEEN device or system as in FIG. 2 that places a direct 911 call in response to either a HELP/MAYDAY request or an automatic detection of a vehicle crash.

A novel technique for automatically transferring data using TTY communications of a short length text messages followed by a speech message that reads the text message has been described. Several embodiments were described for an application of this technique to solve the important problem of transferring emergency event data from a vehicle, or other transport, to a 911 PSAP operator. Many other applications and embodiments of the application should be obvious to one skilled in the art. In terms of application examples, these techniques can be used to assist other TTY communications, e.g., non-emergency, where the receiving party can benefit from a voicing of the TTY characters, words or phrases, in order to improve communications. In terms of embodiment examples, the above description emphasizes the called human party reading the TTY text and listening to the validating speech message in order to detect transmission/reception errors. In other embodiments the reading and listening may be automated, for example, using machine/computer based optical character ‘reading’ technologies and speech recognition ‘listening’ technologies.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium (non-transitory storage medium) may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components.

Although an exemplary embodiment of the system, method, and computer readable medium of the present application has been illustrated in the accompanied drawings and described in the foregoing detailed description, it will be understood that the application is not limited to the embodiments disclosed, but is capable of numerous rearrangements, modifications, and substitutions without departing from the spirit or scope of the application as set forth and defined by the following claims. For example, the capabilities of the systems can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments of the present application. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the application as discussed above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent, while remaining within the spirit and scope of the application. In order to determine the metes and bounds of the application, therefore, reference should be made to the appended claims.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
receiving motor vehicle emergency sensor data;
identifying an emergency event has occurred in a motor vehicle based on the emergency sensor data;
generating an emergency text message via a mobile communication device associated with the vehicle comprising a summary of at least one of a vehicle emergency event and the associated emergency sensor data;
transmitting the emergency text message to emergency services;
generating an automated voice speech message that audibly reads the emergency text message data to an emergency services recipient; and
transmitting the voice speech message to the emergency services recipient.

2. The method of claim 1, further comprising:
receiving a two-way voice communication session between an emergency services call center associated with the emergency services and the mobile communication device associated with the vehicle.

3. The method of claim 1, further comprising:
transmitting a call to emergency services; and
monitoring the call to determine whether a predetermined amount of time has passed without a connection; and
if no connection is established after the predetermined amount of time then reinitiating the call by transmitting another call to emergency services.

4. The method of claim 1, wherein the at least one vehicle emergency event and the emergency sensor data comprises at least one of an impact angle, change in velocity, seatbelt usage, multiple impacts and vehicle type.

5. The method of claim 1, further comprising:
transmitting a resend inquiry message to the emergency services to determine whether the emergency services recipient desires to have any of the previously transmitted information resent;
receiving a confirmation message from the emergency services that a resend is requested; and
re-transmitting at least one of the automated voice speech message and the text message to the emergency services recipient.

6. The method of claim 1, further comprising:
receiving a text message from the emergency services; and
determining whether the emergency services text message is comprised of a predetermined set of text characters; and
if so, then establishing a two-way text message communications mode between the vehicle and the emergency services.

7. The method of claim 6, wherein if the emergency services text message did not include the predetermined set of text characters then re-establishing a two-way voice communication session between the emergency services and the occupants of the vehicle.

8. An apparatus comprising:
a receiver configured to receive motor vehicle emergency sensor data;
a processor configured to
identify an emergency event has occurred in a motor vehicle based on the emergency sensor data;
generate an emergency text message comprising a summary of at least one of a vehicle emergency event and the associated emergency sensor data; and
a transmitter configured to transmit the emergency text message to emergency services, and
wherein the processor is further configured to generate an automated voice speech message that audibly reads the emergency text message data to an emergency services recipient, and wherein the transmitter is further configured to transmit the voice speech message to the emergency services recipient.

9. The apparatus of claim 8, wherein the receiver is further configured to receive a two-way voice communication session between an emergency services call center associated with the emergency services and the vehicle.

10. The apparatus of claim 8, wherein the transmitter is further configured to transmit a call to emergency services, and the processor is further configured to monitor the call to determine whether a predetermined amount of time has passed without a connection, and if no connection is established after the predetermined amount of time then reinitiating the call by transmitting another call to emergency services.

11. The apparatus of claim 8, wherein the at least one vehicle emergency event and the emergency sensor data comprises at least one of an impact angle, change in velocity, seatbelt usage, multiple impacts and vehicle type.

12. The apparatus of claim 8, wherein the transmitter is further configured to transmit a resend inquiry message to the emergency services to determine whether the emergency services recipient desires to have any of the previously transmitted information resent, the receiver is further configure to receive a confirmation message from the emergency services that a resend is requested, and the transmitter is further configured to re-transmit at least one of the automated voice speech message and the text message to the emergency services recipient.

13. The apparatus of claim 8, wherein the receiver is further configured to receive a text message from the emergency services, and the processor is further configured to determine whether the emergency services text message is comprised of a predetermined set of text characters, and if so, then the transmitter establishes a two-way text message communications mode between the vehicle and the emergency services.

14. The apparatus of claim 13, wherein if the emergency services text message did not include the predetermined set of text characters then the transmitter is further configured to re-establish a two-way voice communication session between the emergency services and the occupants of the vehicle.

15. A non-transitory computer readable storage medium configured to store instructions that when executed cause a processor to perform:
receiving motor vehicle emergency sensor data;
identifying an emergency event has occurred in a motor vehicle based on the emergency sensor data;
generating an emergency text message via a mobile communication device associated with the vehicle comprising a summary of at least one of a vehicle emergency event and the associated emergency sensor data;
transmitting the emergency text message to emergency services;
generating an automated voice speech message that audibly reads the emergency text message data to an emergency services recipient; and
transmitting the voice speech message to the emergency services recipient.

16. The non-transitory computer readable storage medium of claim 15, wherein the processor is further configured to perform:
receiving a two-way voice communication session between an emergency services call center associated with the emergency services and the mobile communication device associated with the vehicle.

17. The non-transitory computer readable storage medium of claim 15, wherein the processor is further configured to perform:
transmitting a call to emergency services;
monitoring the call to determine whether a predetermined amount of time has passed without a connection; and
if no connection is established after the predetermined amount of time then reinitiating the call by transmitting another call to emergency services.

18. The non-transitory computer readable storage medium of claim 15, wherein the processor is further configured to perform, wherein the at least one vehicle emergency event and the emergency sensor data comprises at least one of an impact angle, change in velocity, seatbelt usage, multiple impacts and vehicle type.

19. The non-transitory computer readable storage medium of claim 15, wherein the processor is further configured to perform:
transmitting a resend inquiry message to the emergency services to determine whether the emergency services recipient desires to have any of the previously transmitted information resent;
receiving a confirmation message from the emergency services that a resend is requested; and
re-transmitting at least one of the automated voice speech message and the text message to the emergency services recipient.

20. The non-transitory computer readable storage medium of claim 15, wherein the processor is further configured to perform:
receiving a text message from the emergency services;
determining whether the emergency services text message is comprised of a predetermined set of text characters;
if so, then establishing a two-way text message communications mode between the vehicle and the emergency services; and
if the emergency services text message did not include the predetermined set of text characters then re-establishing a two-way voice communication session between the emergency services and the occupants of the vehicle.
